(19) United States
(12) Patent Application Publication
(10) Pub. No.: US 2025/0103068 A1
(43) Pub. Date: Mar. 27, 2025

(54) METHOD FOR OPERATING A VEHICLE SEAT COMFORT SYSTEM

(71) Applicant: Faurecia Autositze GmbH, Hannover (DE)

(72) Inventors: Piotr Ceglarek, Katowice (PL); Tomasz Stasinski, Dzierzoniaw (PL)

(73) Assignee: Faurecia Autositze GmbH, Hannover (DE)

(21) Appl. No.: 18/730,138

(22) PCT Filed: Jan. 18, 2023
(86) PCT No.: PCT/EP2023/051070

§ 371 Date: Jul. 18, 2024

(30) Foreign Application Priority Data
Jan. 28, 2022 (DE) 10 2022 102 073.8

(51) Int. Cl. G05D 7/06; B60N 2/02; B60N 2/90

(52) U.S. Cl. CPC G05D 7/0623; B60N 2/0224; B60N 2/919; G05D 7/0635; B60N 2002/924

(57) ABSTRACT

A method for operating a vehicle seat comfort system in which pneumatic components are supplied with fluid by opening and closing at least one solenoid valve. The solenoid valve is opened and closed by applying an electric supply voltage (V). In the opening phase of the solenoid valve, the supply voltage (V) is increased up to a maximum value (V2) in the form of a voltage ramp in a plurality of steps, and in a closing phase of the solenoid valve, the supply voltage (V) is reduced in comparison to the maximum value (v2). In the opening phase of the solenoid valve, the supply voltage (V) is reduced after at least one process of increasing the supply voltage (V) or after each process of increasing the supply voltage.

### CROSS REFERENCE TO RELATED APPLICATIONS

This application is the US national phase of and claims the benefit of and priority on International Application No. PCT/EP2023/051070 having an international filing date of 18 Jan. 2023, which claims priority on and the benefit of German Patent Application No. 10 2022 102 073.8 having a filing date of 28 Jan. 2022.

### BACKGROUND OF THE INVENTION

### Technical Field

The invention relates to a method for operating a vehicle seat comfort system.

### Prior Art

Vehicle seat comfort systems are often controlled by pneumatic systems in which solenoid valves are used that must be opened and closed to perform seat comfort functions, such as a massage or seat adjustment. The solenoid valves are supplied with a supply voltage by means of which they can be opened and closed. Normally during opening, a relative displacement of two components that interact magnetically with each other, such as a piston and an electromagnet interacting therewith, often occurs against the bias of a spring so that the piston or generally the locking part returns to the closed state in the absence of a power supply. When such a valve is switched, a trigger voltage is required to move the piston or the movable locking part from a closed to an open position. Depending on how abruptly this switching occurs, noises often occur during the switching process because the piston or the closing part is strongly accelerated and is therefore moved at high speed into the open state or against the valve seat.

In fuel injection systems or vehicle brakes, such as those known from EP 0 840684 B1, which are operated using solenoid valves, it is known to reduce the development of noise by not applying the supply voltage of the corresponding solenoid valve immediately to the solenoid valve, but by using a voltage ramp so that the locking part or the piston starts moving at a reduced speed. This can already achieve a reduction in the development of noise. While in fuel injection systems where the valves are located close to the engine, the noise generated when the solenoid valves are switched does not play such a major role due to the ambient noise that is present when a vehicle is in operation in any case, this is certainly the case with vehicle seat comfort systems which are usually located in the immediate vicinity of a vehicle occupant and whose noise generation is therefore perceived more strongly.

### BRIEF SUMMARY OF THE INVENTION

The object of the present invention is to provide a method for operating a vehicle seat comfort system in which the generation of noise can be reduced by the switching operations of the solenoid valves used.

This object is achieved by a method for operating a vehicle seat comfort system, in which pneumatic components are supplied with fluid by opening and closing at least one solenoid valve, whereby the solenoid valve is opened and closed by applying an electrical supply voltage (V), wherein, in the opening phase of the solenoid valve, the supply voltage (V) is increased in the form of a voltage ramp in a plurality of steps up to a maximum value (V2), and in a closing phase of the solenoid valve, the supply voltage (V) is reduced with respect to the maximum value (V2), wherein, in the opening phase of the solenoid valve, the supply voltage (V) is reduced after at least one instance where the supply voltage (V) is increased, or after each instance where the supply voltage is increased, as well as by a vehicle seat comfort system for carrying out a method as taught herein, comprising a pneumatic system, a vehicle seat and at least one pneumatic component that is operated by the pneumatic system and integrated in the vehicle seat, preferably a fluid actuator, wherein the pneumatic system comprises at least one solenoid valve that is operated with a supply voltage (V). Advantageous embodiments can be found in the dependent claims.

In the method according to the invention for operating a vehicle seat comfort system, pneumatic components are supplied with fluid by opening and closing at least one solenoid valve. This is done by opening and closing the solenoid valve by applying an electrical supply voltage. During the opening phase of the solenoid valve, the supply voltage is increased in the form of a voltage ramp in a plurality of steps up to a maximum value. Accordingly, the supply voltage is reduced from the maximum value during a closing phase of the solenoid valve. According to the invention, in the opening phase of the solenoid valve, the supply voltage is reduced after at least one instance where the supply voltage is increased or each instance where the supply voltage is increased. Each increase causes the moving part of the solenoid valve to accelerate. Lowering the voltage after the stepwise increase therein ensures that the successive acceleration is slowed down overall so that the moving part of the solenoid valve is not moved at too high a speed and therefore lead to opening noises that arise as a result of strong acceleration, and therefore to noise generated when the moving part hits the open position is reduced overall. In particular, this also avoids clicking noises during opening.

Preferably, the change, i.e. the reduction or increase in the supply voltage, can be carried out linearly or according to a predetermined, preferably parameterized, curve shape. The curve shape should be selected primarily on the basis of the magnetic characteristics of the solenoid valve. The number of steps for increasing or decreasing the supply voltage can also be adjustable. In principle, it is possible for the curve of the supply voltage to have any shape, as long as the increase or decrease in the supply voltage occurs in steps.

According to a further preferred variant of the method according to the invention, it is provided that, in the opening phase, the movable part, preferably the piston, of the solenoid valve is moved away from its valve seat and, in the closing phase, is moved toward the valve seat. In principle, the solenoid valve can be biased toward the closed position, for example by a spring or the like. Of course, the same naturally also applies in principle in the opposite direction, i.e. toward the open position.

In principle, any method is conceivable with which the voltage ramp required according to the invention can be used. However, the supply voltage is preferably controlled by means of a PWM signal. The duration of a step, i.e. the duration starting with the voltage increase up to the lowest point of the subsequent voltage drop of a step, must be selected so that the voltage increase is not too fast but also not too slow. It has been found to be advantageous for the duration of a step in the opening phase to be 30 ns to 70 ns, preferably 40 ns to 60 ns, most preferably 50 ns.

Lastly, the invention relates to a vehicle seat comfort system for carrying out the method described above. This vehicle seat comfort system has a pneumatic system, a vehicle seat and at least one pneumatic component, preferably a fluid actuator, that is operated by the pneumatic system and integrated in the vehicle seat. The pneumatic system comprises at least one solenoid valve that is operated with a supply voltage.

### BRIEF DESCRIPTION OF THE DRAWINGS

The invention will be explained in more detail below with reference to FIGS. 1-4.

FIG. 1 shows an exemplary voltage/time curve when actuating a solenoid valve in accordance with the method according to the invention.

FIG. 2 shows an enlargement of detail B from FIG. 1 in a first method variant.

FIG. 3 shows an enlargement of detail B from FIG. 1 in a second method variant.

FIG. 4 shows an enlargement of detail B from FIG. 1 in a third method variant.

### DETAILED DESCRIPTION OF PREFERRED EMBODIMENTS

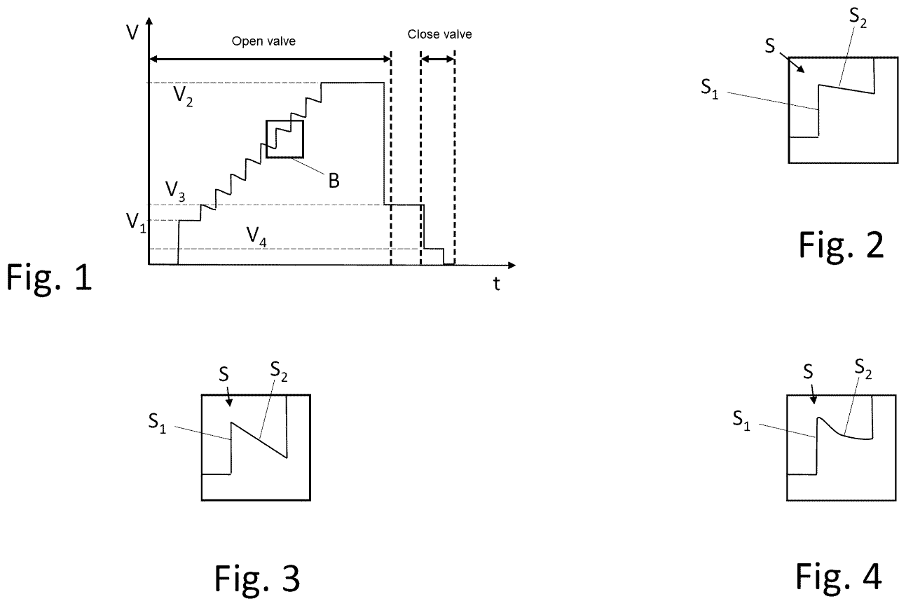

FIG. 1 shows an example of a curve of the supply voltage V according to the invention as a function of time t. Shown is a typical step-by-step or incremental voltage curve when opening and closing a solenoid valve.

For the opening process, the voltage V at the solenoid valve is increased step by step, first to a level V1, then in a plurality of further steps up to a level V2; at this level V2, the solenoid valve is completely open. The supply voltage can be reduced to near a threshold value V3 after the solenoid valve has been fully opened, i.e. after the voltage level V2 has been reached. V3 indicates a threshold value below which the moving part of the solenoid valve can no longer be kept open and returns to its closed position. Lowering the voltage level of the supply voltage V to the threshold value V3 saves energy while keeping the solenoid valve open. Finally, to close the solenoid valve, the voltage can be further reduced in stages from level V3 to level V4 and finally to zero.

It can be seen in FIG. 1 that, according to the invention, the step-by-step or incremental increase in the supply voltage V from level V1 to level V2 is always accompanied by said voltage being reduced again after a level has been reached. By lowering the supply voltage in this way after step where it is increased, the moving part of the solenoid valve, for example a piston or the like, experiences slower acceleration than would be the case if such a reduction did not take place. Due to this counter-acceleration, despite the step-by-step increase in the supply voltage of the solenoid valve, the moving part of the solenoid valve is thus also slightly braked at the same time so that jerky opening and thus strong noise generation is avoided.

The curve shape is to be explained using the example of detail B from FIG. 1 with reference to three further embodiments.

In FIG. 2, it can be seen that a voltage-increasing step S according to the invention has a rising edge S1 and a falling edge S2 before the next voltage-increasing step S follows. In the example shown in FIG. 2, the rising edge S1 is shown in a simplified manner as a sudden increase; of course, the rising edge could equally represent a comparatively more slowly rising straight line or another curve rising in any desired manner, preferably monotonously or strictly monotonously. The same applies to the falling edge S2: this can be—as in the example shown—a falling straight line or any other form of a falling curve, preferably a monotonously or strictly monotonously falling curve. In principle, the curve shape of the supply voltage curve shown in FIG. 1 can be parameterized as desired, as long as there is at least a small drop in the supply voltage between two increases in the supply voltage.

FIG. 3 shows a further example of the shape of a step S, which has a steeper falling second edge S2 compared to the embodiment shown in FIG. 2. As a result, the moving part of the solenoid valve as a whole is accelerated even more slowly when the valve is opened compared to the embodiment shown in FIG. 2.

The rising edge S1 of one stage can have a different course than that shown, for example, in FIG. 4, but the falling edge S2 can also have a course that is not linear, as indicated in FIG. 4.

Of course, other curve shapes are conceivable than those shown in the above-described drawings. In particular, other curve shapes with other step shapes, in particular also shapes which have been described with reference to FIGS. 2-4, can of course be provided when the solenoid valve is closed.

With the present invention, the movable part, preferably a piston, of a solenoid valve can be opened or closed with significantly less noise generation. This is achieved by the fact that, preferably by controlling the supply voltage of the solenoid valve by means of PWM signals, the special curve in particular of the voltage curve when the solenoid valve opens between two voltage-increasing steps includes a drop in the supply voltage. As a result, the moving part is accelerated less strongly than with conventional solutions, so that the corresponding noise development is also thereby reduced.

The present invention is particularly suitable for use in vehicle seat comfort systems, for example in seat adjustments or massage systems that are pneumatically operated and as a result of which the noise generation is often perceived as disturbing. The invention provides a remedy in that a significant reduction in noise generation can be achieved by means of the method according to the invention.

1. A method for operating a vehicle seat comfort system, in comprising supplying pneumatic components are supplied with fluid by opening and closing at least one solenoid valve, whereby the solenoid valve is opened and closed by applying an electrical supply voltage (V), wherein, in the opening phase of the solenoid valve, the supply voltage (V) is increased in the form of a voltage ramp in a plurality of steps up to a maximum value (V2), and in a closing phase of the solenoid valve, the supply voltage (V) is reduced with respect to the maximum value (V2), wherein, in the opening phase of the solenoid valve, the supply voltage (V) is reduced after at least one instance where the supply voltage (V) is increased, or after each instance where the supply voltage is increased.

2. The method according to claim 1, wherein the change, reduction or increase in the supply voltage (V) occurs linearly or according to a predetermined curve shape.

3. The method according to claim 1, wherein, in the opening phase, the piston of the solenoid valve is moved away from its valve seat, and in the closing phase, is moved toward the valve seat.

4. The method according to claim 1, wherein in that the supply voltage (V) is controlled by means of a PWM signal.

5. A vehicle seat comfort system for carrying out a method according to claim 1, comprising a pneumatic system, a vehicle seat and at least one pneumatic component that is operated by the pneumatic system and integrated in the vehicle seat, preferably a fluid actuator, wherein the pneumatic system comprises at least one solenoid valve that is operated with a supply voltage (V).
